(19) United States
(12) Patent Application Publication
(10) Pub. No.: US 2026/0318150 A1
(43) Pub. Date: Oct. 15, 2026

(54) CURTAIN cord-free SYSTEM

(71) Applicant: WENZHOU DETUO YUHONG INDUSTRIAL CO.,LTD., Wenzhou (CN)

(72) Inventor: Jiabin Huang, Ruian City Wenzhou (CN)

(73) Assignee: WENZHOU DETUO YUHONG INDUSTRIAL CO.,LTD., Wenzhou (CN)

(21) Appl. No.: 19/553,814

(22) Filed: Mar. 2, 2026

(30) Foreign Application Priority Data
Apr. 10, 2025 (CN) 202510448213.9

(51) Int. Cl. E06B 9/44

(52) U.S. Cl. CPC E06B 9/44

(57) ABSTRACT

The present invention discloses a curtain cord-free system, comprising a fixed base and a curtain rolling tube rotating on the fixed base, the curtain rolling tube is internally provided with a limiter assembly and a spring assembly, and the limiter assembly comprises a limit screw and a nut that fits with the limit screw thread; the spring assembly comprises a base, and a spring box rotatably provided with a spring module, multiple spring boxes are connected in sequence to interconnect their internal spring modules, and both the spring box and the base are fixed to the curtain rolling tube in the circumferential direction; the rotating member is fixedly connected to the fixed base. In the present invention, the regulation of spring assembly enables free stacking for elasticity regulation to better adapt to the weight of different curtains, characterized by a stable structure and simple assembly with improved safety.

### REFERENCE TO PRIOR APPLICATION

This application claims priority to Chinese Patent Application 202510448213.9, filed on Apr. 10, 2025, which is incorporated herein by reference.

### TECHNICAL FIELD

The present invention relates to the field of curtain technology, and more specifically, relating to a curtain cord-free system.

### BACKGROUND

At present, most curtains on the market are provided with a cord that is too long and unsightly, posing a hidden danger to places where children play around and, and may cause danger and it is very unsafe as children's necks are easily tangled. Therefore, cord-free curtains are becoming increasingly popular among the public due to their safety and aesthetic features.

In the prior art, for example, the elastic winding structure on a roll curtain disclosed under the publication number CN210087207U adjusts the spring force by stacking several spiral springs on the clamping rod to adapt to the weight of different curtains, however, some defects have been found in the use of this structure: firstly, although this structure can adjust the elastic force by stacking the number of spiral springs, but the number of springs that can be stacked is affected by the length of clamping rod, and when more spiral springs need to be stacked, the adaptive length of the clamping rod has to be extended; secondly, the extended part will affect the strength of clamping rod and, in reality, this structure cannot stack too many spiral springs, with limited adjustment of elastic force. The traditional method of reverse installation of spiral springs poses a danger during assembly, and inaccurate installation may easily cause the spiral spring pop out, injuring the installation personnel.

### SUMMARY

To address the existing shortcomings of prior art, the present invention provides a curtain cord-free system, the regulation of spring assembly enables free stacking for elasticity regulation to better adapt to the weight of different curtains, characterized by a stable structure and simple assembly with improved safety.

To achieve the above objectives, the present invention provides the following technical solutions: a curtain cord-free system, comprising a fixed base and a curtain rolling tube rotating on the fixed base, the curtain rolling tube is internally provided with a limiter assembly and a spring assembly, and the limiter assembly comprises a limit screw and a nut that fits with the limit screw thread, and the nut is fixed in the circumferential direction with the curtain rolling tube; the spring assembly comprises a base, and at least a spring box rotatably provided with a spring module, and when there are multiple spring boxes, the multiple spring boxes are connected in sequence to interconnect their internal spring modules, the head end of the interconnected spring module is connected to a limit screw, and the tail end is connected to a rotating member inside the base, and both the spring box and the base are fixed to the curtain rolling tube in the circumferential direction; the rotating member is fixedly connected to the fixed base.

The present invention is further configured as follows: the spring module internally comprises a rotating rod, a coil spring is disposed adjacent to the rotating rod, and the outer end of the coil spring is fixedly connected to the rotating rod.

The present invention is further configured as follows: the two ends of the rotating rod are respectively provided with a concave gear groove and a protruding gear part, and the gear groove and gear part are insert-fitted.

The present invention is further configured as follows: the spring box comprises a box body and a box cover, the box body is provided with a slot, the bottom end of the slot is provided with an opening inclined surface, the box cover is provided with a foot clamp having a block, the foot clamp extends into the slot, so that the opening inclined surface extends the foot clamp outward, and at the same time, the slot and the block are snap-fitted.

The present invention is further configured as follows: the two ends of the spring box are provided with a rotating locking structure, and several spring boxes are sequentially connected through the rotating locking structure.

The present invention is further configured as follows: the rotating locking structure comprises several first locking members located at one end of the spring box and second locking members, the same number as the first locking members, located at the other end, and the cross-sections of the first locking member and the second locking member are both an L-shaped structure, and at least one of the several first locking members and second locking members has a stopper that restricts rotation.

The present invention is further configured as follows: a curtain cord-free system, further comprising a transition connector disposed between the spring module and the limit screw, and a gear set is disposed inside the transition connector for transmission connection between the spring module and the limit screw.

The present invention is further configured as follows: one end of the rotating member meshes with a spring module through a gear, and the other end is provided with a limit groove, the fixed base is provided with a fixing piece that is snap-fitted with the limit groove.

The present invention is further configured as follows: the base comprises a pre-tightening locking mechanism with a locked state and an unlocked state, and in the locked state, the pre-tightening locking mechanism locks the rotation of rotating member and in the unlocked state, allows for the rotatable adjustment of the rotating member.

The present invention is further configured as follows: the pre-tightening locking mechanism comprises a pin type structure and a spring type structure, the pin type structure is fixed when a pin is inserted into a rotating member, and the spring type structure is fixed when the rotating member pops out for locking purpose.

In summary, the present invention has the following beneficial effects:

The present invention provides a spring box, and several identical spring boxes can be connected in sequence and then, the head and tail ends of the internal spring module are connected to the limit screw and rotating member and in this way, to adjust the elastic force, it is only necessary to stack the number of spring boxes arbitrarily, and then add limiter assembly and base at the head and tail ends and at the same time, the design in the present invention links the spring modules together to form a stable and reliable structure during elastic force adjustment.

The spring box of the present invention is provided with a rotating rod and a coil spring, which are connected through the insertion of gear groove and gear part and during assembly, multiple spring boxes only need to be sequentially connected, and the coil spring structure will not pop out, characterized by simple, reliable, and safe assembly.

### BRIEF DESCRIPTION OF DRAWINGS

FIG. 1 is a schematic diagram of the overall curtain structure.

FIG. 2 is a schematic diagram of the overall structure of the fixed base and curtain rolling tube.

FIG. 3 is a schematic diagram of the internal cross-sectional structure of the curtain rolling tube.

FIG. 4 is a schematic diagram of the exploded structure of the limiter assembly and spring assembly.

FIG. 5 is a schematic diagram of the internal structure of the spring assembly and transition connector.

FIG. 6 is a schematic diagram of the structure of the box body and box cover.

FIG. 7 is a schematic diagram of the sequential connection structure of multiple spring boxes.

FIG. 8 is a structural diagram of two embodiments of the warning locking mechanism.

FIG. 9 is a structural diagram of the second embodiment of the warning locking mechanism.

### REFERENCE NUMBER

10. Fixed base; 1001. Fixing piece; 11. Curtain rolling tube; 1101. Curtain body; 2. Limiter assembly; 201. Limit screw; 202. Nut; 3. Spring assembly; 301. Spring box; 302. Base; 4. Spring module; 401. Rotating rod; 4011. Gear groove; 4012. Gear part; 402. Coil spring; 5. Rotating member; 501. Limit groove; 6. Box body; 601. Slot; 602. Opening inclined surface; 7. Box cover; 701. Foot clamp; 702. Block; 8. Rotating locking structure; 801. First locking member; 802. Second locking member; 803. Stopper; 9. Transition connector; 12. Damper; 13. Pre-tightening locking mechanism; 14. Pin; 15. Spring; 16. Transmission rib; 17. Transmission fitting groove; 18. Fixed rib.

### DETAILED DESCRIPTION OF EMBODIMENTS

The present invention will be further described in detail below in combination with drawings.

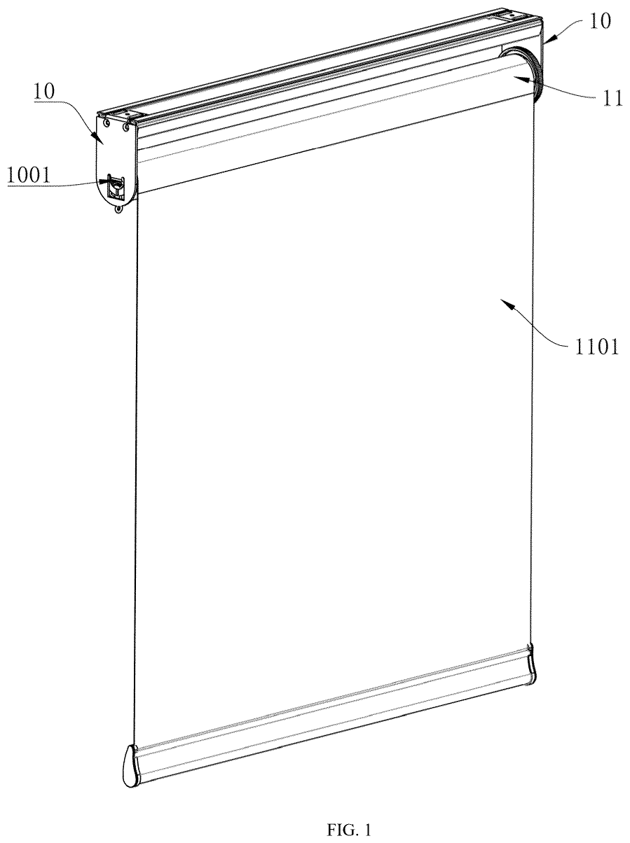

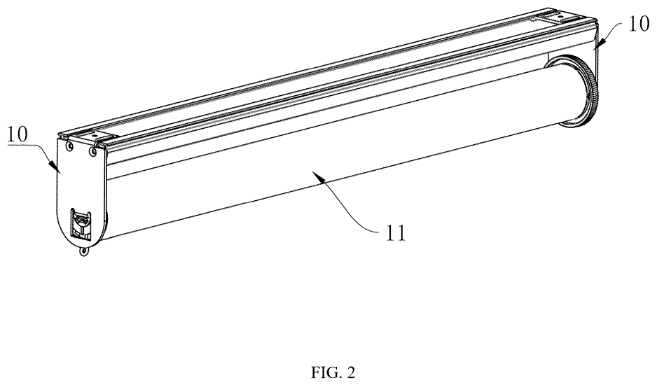

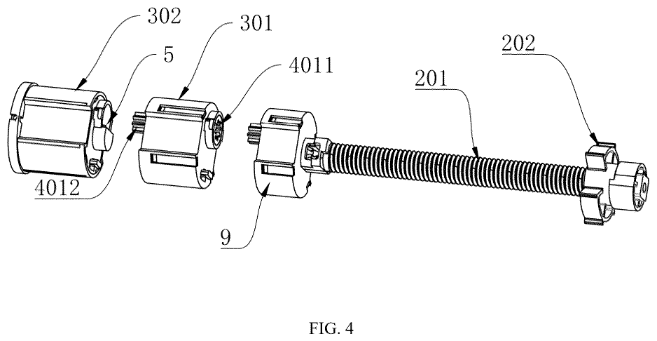

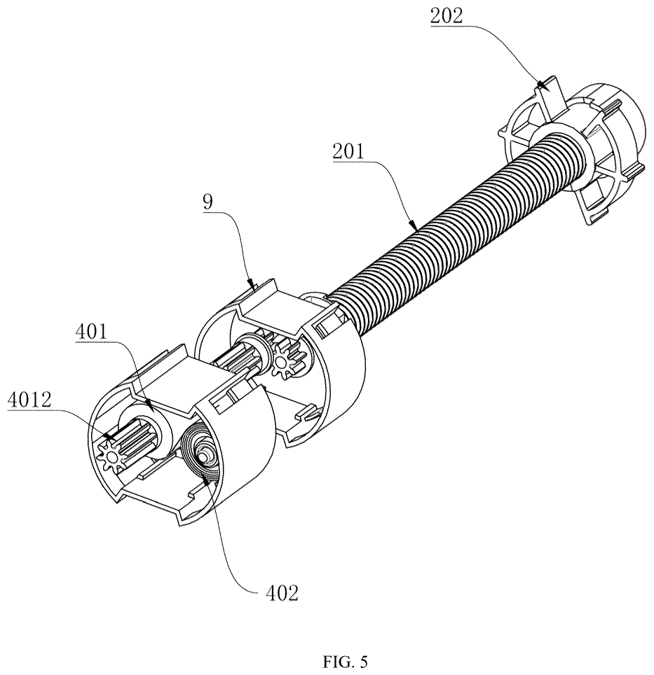

The embodiment discloses a curtain cord-free system, as shown in FIG. 1-9, comprising a fixed base 10 and a curtain rolling tube 11 rotating on the fixed base 10, the curtain rolling tube 11 is internally provided with a limiter assembly 2 and a spring assembly 3; the limiter assembly 2 comprises a limit screw 201 and a nut 202 that fits with the limit screw thread 201; the nut 202 is fixed in the circumferential direction with the curtain rolling tube 11 and as shown in FIG. 4, a convex rib that can be embedded with the inner wall of the curtain rolling tube 11 is provided on the peripheral side of the nut 202 to achieve circumferential fixation between the two; the spring assembly 3 comprises a base 302, and at least a spring box 301 rotatably provided with a spring module 4, and when there are multiple spring boxes 301, the multiple spring boxes 301 are connected in sequence to interconnect their internal spring modules 4, the head end of the interconnected spring module 4 is connected to a limit screw 201, and the tail end is connected to a rotating member 5 inside the base 302, and both the spring box 301 and the base 302 are fixed to the curtain rolling tube 11 in the circumferential direction; as shown in FIG. 4, convex ribs that can be embedded into the inner wall of the curtain rolling tube can also be provided on the periphery of the spring box 301 and the base 302, thereby achieving a circumferential fixed connection between the spring box 301, the base 302, and the curtain rolling tube; the rotating member 5 is fixedly connected to the fixed base 10, so that the gear transmission of the spring box 301 fixes the limit screw 201, and the rotating curtain rolling tube 11 drives the limit nut 202 to rotate and to move axially on the limit screw 201 and move between the two ends of the limit screw 201, thereby limiting the rotation stroke of the curtain rolling tube 11.

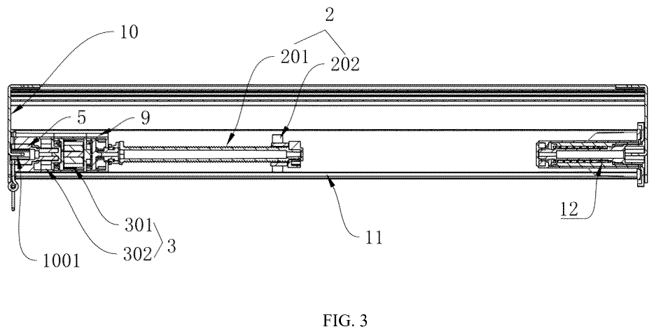

In further, as shown in FIG. 3-5, the spring module 4 internally comprises a rotating rod 401, a coil spring 402 is disposed adjacent to the rotating rod 401, and the outer end of the coil spring 402 is fixedly connected to the rotating rod 401. Therefore, when the curtain body is pulled down, the rotating curtain rolling tube 11 drives the spring box 301 to rotate, the rotating rod 401 is connected to the fixed base 10 through the rotating member 5, so the rotating rod 401 is actually stationary and when the rotating rod 401 rotates relative to the spring box 301, the coil spring 402 will wrap around the rotating rod 401, thereby balancing the pulling force during the downward pulling to suspend the curtain body.

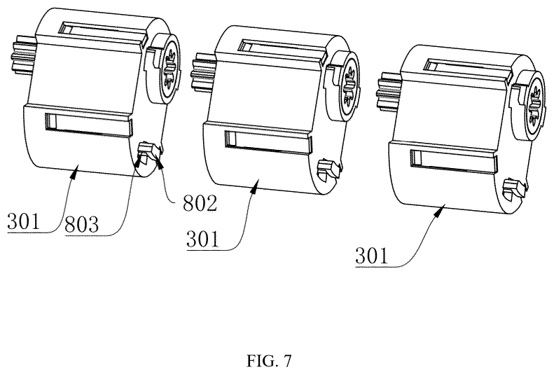

In further, as shown in FIG. 4 and FIG. 7, the two ends of the rotating rod 401 are respectively provided with a concave gear groove 4011 and a protruding gear part 4012, and the gear groove 4011 and gear part 4012 are insert-fitted. In the above structure and as shown in FIG. 4, the gear part 4012 is used to mesh with the rotating member 5 in the base 302, and the gear groove 4011 is inserted with the gear set on the transition connector 9 that is between the spring module 4 and the limit screw 201, which is used to drive and connect the spring module 4 with the limit screw 201, realizing the interconnection of various components. Meanwhile, as shown in FIG. 7, the above structure can also be used for sequential insertion and connection of multiple gear boxes 301 and in this way, according to the weight requirements of different curtain bodies, theoretically, random number of spring boxes 301 can be arbitrarily stacked to enable flexible adjustment of elastic force, making assembly convenient and fast. Compared to the traditional assembly of spiral springs, the structure of spring box 301 is also safer and more reliable.

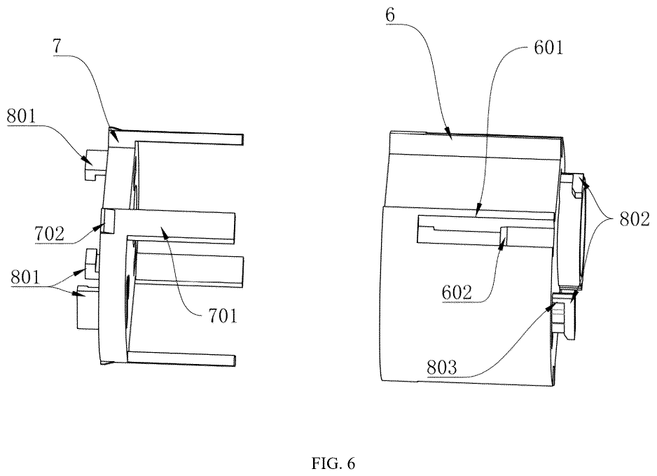

In further, as shown in FIG. 6, the spring box 301 comprises a box body 6 and a box cover 7, and in order to ensure the stability of box body 6 and box cover 7 after installation, the box body 6 is provided with a slot 601, the bottom end of the slot 601 is provided with an opening inclined surface 602, the box cover 7 is provided with a foot clamp 701 having a block 702, the foot clamp 701 extends into the slot 601, so that the opening inclined surface 602 extends the foot clamp 701 outward, and at the same time, the slot 601 and the block 702 are snap-fitted. By means of the above structure, when the box body 6 and the box cover 7 are being installed, the foot clamp 701 is inserted into the slot 601, and then the foot clamp 701 is pressed against the opening inclined surface 602, and is pushed outward by the opening inclined surface 602; meanwhile, the block 702 is also stuck with the end face of the slot 601 and due to the effect of the opening inclined surface, the foot clamp 701 has a greater force to open outward, making the block 702 and the end face of slot 601 stuck and compared with traditional buckle structures, the structure in this embodiment is more firm and reliable.

In further, as shown in FIG. 6-7, the two ends of the spring box 301 are provided with a rotating locking structure 8, and several spring boxes 301 are sequentially connected through the rotating locking structure 8; the rotating locking structure 8 comprises several first locking members 801 located at one end of the spring box 301 and second locking members 802, the same number as the first locking members 801, located at the other end, and the cross-sections of the first locking member 801 and the second locking member 802 are both an L-shaped structure, and at least one of the several first locking members and second locking members has a stopper 803 that restricts rotation. By means of the above structure, when several spring boxes 301 are connected, it is simply required to align the first locking member 801 and the second locking member 802, then rotate them from the opening of the L-shaped structure to lock them together, and then limit them with the stopper 803 to achieve fixation; a protruding rib structure can be provided on the first locking member 801 or the second locking member 802 to ensure that they do not loosen after rotation. Referring again to FIG. 4, a rotating locking structure 8 is also provided at the corresponding positions of the base 302 and the transition connector 9 for connecting with the spring box 301.

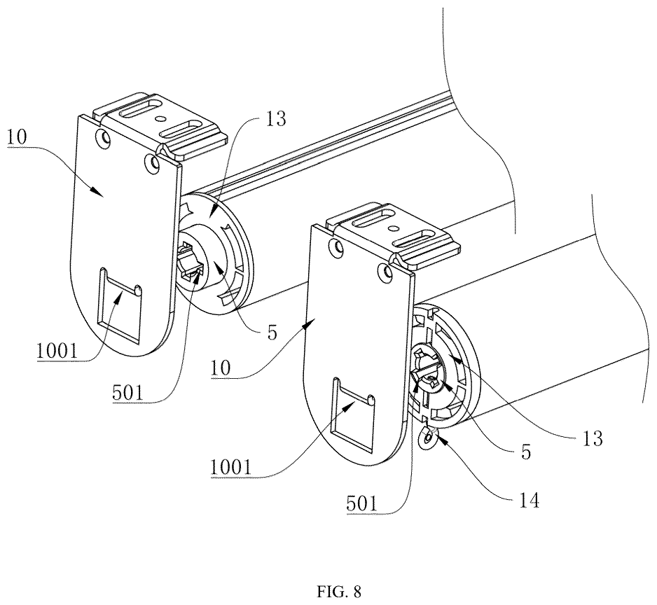

In further, as shown in FIG. 3 and FIG. 8, one end of the rotating member 5 meshes with a spring module through a gear, and the other end is provided with a limit groove 501, the fixed base 10 is provided with a fixing piece 1001 that is snap-fitted with the limit groove 501. The fixing piece 1001 is a bent piece that is inserted into the limit groove of rotating member 5, thereby fixing the rotating member 5 to prevent from rotating.

In further, as shown in FIG. 8, the base 302 comprises a pre-tightening locking mechanism 13 with a locked state and an unlocked state, and in the locked state, the pre-tightening locking mechanism 13 locks the rotation of rotating member 5 and in the unlocked state, allows for the rotatable adjustment of the rotating member 5. The function of the pre-tightening locking mechanism 13 is to pre-adjust the spring force and prevent the rotation of rotating member 5 before it is installed on the fixing piece of the fixed base 10. The pre-tightening locking mechanism 13, according to different structural methods, has two embodiments;

### Embodiment 1

Embodiment 1 is a pin type pre-tightening lock, as shown in the lower right corner of FIG. 8, which is inserted into the rotating member 5 through a pin 14 that passes through the side wall of the base 302 from the outside; the locked state refers to the state where pin 14 is inserted, while the unlocked state refers to the state when the pin is pulled out. During specific use, pull out the pin 14, and then use a screwdriver or other tool to drive the rotating member 5, so that the rotating member 5 drives the internal spring module 4 to rotate, performing pre-adjustment of the elastic force and after the adjustment, insert the pin 14 for locking and after the fixed base and fixing piece is installed, pull out the pin 14 to allow the fixing piece 1001 restrict the rotation of the rotating member 5.

### Embodiment 2

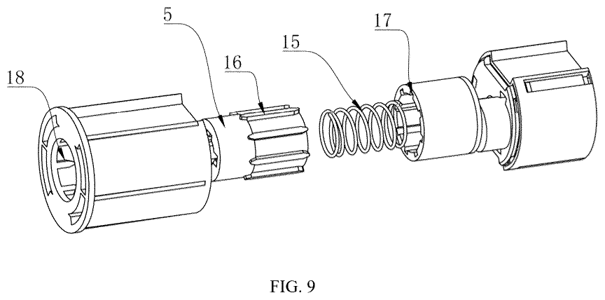

Embodiment 2 is a spring-loaded pre locking structure, as shown in the upper left corner of FIG. 8, which has a pop-up rotating member 5 and is in a locked state when popped out, and when rotation adjustment is required, the rotating member 5 can be pressed inward to unlock and achieve rotation and, as shown in FIG. 9, the base has a fixed rib 18, and the rotating member 5 is divided into two parts: one part has a transmission rib 16 on the circumferential side, and the other part has a transmission fitting groove 17, thereby enabling circumferential fixation of the two parts; a spring 15 is provided between the two parts to achieve elasticity and in the normal popping state, the transmission rib 16 fits with the fixed rib 18 and transmission fitting groove 17. The presence of fixed rib 18 disables the free rotation relative to the base and when pressed inward, the transmission rib 16 only fits with the transmission fitting groove 17, the external tool can drive the rotating member 5 to adjust the elastic force, and after the adjustment is completed, release and allow the rotating member 5 pop out again and be locked by the fixed rib 18 and during installation, the fixing piece is inserted into the limit groove 501 to fix the rotating member 5, and then the rotating base presses rotating member 5 into the unlocked state to achieve installation.

Referring further to FIG. 3, there is also a damper 12 used to fit with the spring assembly 3 to achieve stable rotation of the curtain rolling tube. The damper 12 achieves damping adjustment through friction between the stretched top piece and the inner wall of rolling tube, and the specific structure can refer to the structure of a roller curtain damper disclosed under the publication number CN220101146U, which specific structure will not be further elaborated in the present invention.

Therefore, the improvement of the cord-free system in the present invention makes the adjustment of elastic force more convenient and efficient and theoretically, the number of spring boxes 301 can be arbitrarily stacked, as only as the upper limit screw and base are connected at the head and tail ends of the sequentially connected spring boxes and, for the overall structure of the spring box, multiple spring boxes can be merely connected during assembly, without the need to install multiple spiral springs like in the prior art, and the assembly safety is also stronger.

The embodiments described above, which are merely the preferred ones of the present invention, do not intend to limit the present invention, and any modifications, equivalent substitutions, and improvements made within the design concept of the present invention shall fall within the scope hereof.

1. A curtain cord-free system, comprising a fixed base (10) and a curtain rolling tube (11) rotating on the fixed base (10), the curtain rolling tube (11) is internally provided with a limiter assembly (2) and a spring assembly (3), and the limiter assembly (2) comprises a limit screw (201) and a nut (202) that fits with the limit screw thread (201); the nut (202) is fixed in the circumferential direction with the curtain rolling tube (11) ; the spring assembly (3) comprises a base (302), and at least a spring box (301) rotatably provided with a spring module (4), and when there are multiple spring boxes (301), the multiple spring boxes (301) are connected in sequence to interconnect their internal spring modules (4), the head end of the interconnected spring module (4) is connected to a limit screw (201), and the tail end is connected to a rotating member (5) inside the base (302), and both the spring box (301) and the base (302) are fixed to the curtain rolling tube (11) in the circumferential direction; the rotating member (5) is fixedly connected to the fixed base (10); wherein the spring module (4) internally comprises a rotating rod (401), a coil spring (402) is disposed adjacent to the rotating rod (401), and the outer end of the coil spring (402) is fixedly connected to the rotating rod (401); wherein the base (302) comprises a pre-tightening locking mechanism (13) with a locked state and an unlocked state, and in the locked state, the pre-tightening locking mechanism (13) locks the rotation of rotating member (5) and in the unlocked state, allows for the rotatable adjustment of the rotating member (5).

3. A curtain cord-free system according to claim 1, wherein the two ends of the rotating rod (401) are respectively provided with a concave gear groove (4011) and a protruding gear part (4012), and the gear groove (4011) and gear part (4012) are insert-fitted.

4. A curtain cord-free system according to claim 1, wherein the spring box (301) comprises a box body (6) and a box cover (7), the box body (6) is provided with a slot (601), the bottom end of the slot (601) is provided with an opening inclined surface (602), the box cover (7) is provided with a foot clamp (701) having a block (702), the foot clamp (701) extends into the slot (601), so that the opening inclined surface (602) extends the foot clamp (701) outward, and at the same time, the slot (601) and the block (702) are snap-fitted.

5. A curtain cord-free system according to claim 1, wherein the two ends of the spring box (301) are provided with a rotating locking structure (8), and several spring boxes (301) are sequentially connected through the rotating locking structure (8).

6. A curtain cord-free system according to claim 4, wherein the rotating locking structure (8) comprises several first locking members (801) located at one end of the spring box (301) and second locking members (802), the same number as the first locking members (801), located at the other end, and the cross-sections of the first locking member (801) and the second locking member (802) are both an L-shaped structure, and at least one of the several first locking members and second locking members has a stopper (803) that restricts rotation.

7. A curtain cord-free system according to claim 1, further comprising a transition connector (9) disposed between the spring module (4) and the limit screw (201), and a gear set is disposed inside the transition connector (9) for transmission connection between the spring module (4) and the limit screw (201).

8. A curtain cord-free system according to claim 1, wherein one end of the rotating member (5) meshes with a spring module through a gear, and the other end is provided with a limit groove (501), the fixed base (10) is provided with a fixing piece (1001) that is snap-fitted with the limit groove (501).

9.

10. A curtain cord-free system according to claim 1, wherein the pre-tightening locking mechanism (13) comprises a pin type structure and a spring type structure, the pin type structure is fixed when a pin is inserted into a rotating member (5), and the spring type structure is fixed when the rotating member (5) pops out for locking purpose.
